(19) United States
(12) Patent Application Publication
(10) Pub. No.: US 2024/0016117 A1
(43) Pub. Date: Jan. 18, 2024

(54) PET TOY THAT CAN AUTOMATICALLY SUPPLY FOOD

(71) Applicant: Kadtc Pet Supplies INC, LOS ANGELES, CA (US)

(72) Inventor: CHANGLI WU, Linyi (CN)

(21) Appl. No.: 18/109,464

(22) Filed: Feb. 14, 2023

(30) Foreign Application Priority Data
Jul. 14, 2022 (CN) 202221837380.0

(51) Int. Cl. A01K 5/01; A01K 15/02

(52) U.S. Cl. CPC A01K 5/0114; A01K 15/025

(57) ABSTRACT

A pet toy that can automatically supply food, comprising a base and a rotating dish, the rotating dish is provided with a food inlet, a food storage bin is arranged between the base and the rotating dish, wherein pet foods are added into the food storage bin through the food inlet, the inner edge of the food storage bin is provided with a dispensing channel, below the dispensing channel is the food falling outlet, and the lower surface of the rotating dish is provided with a pushing block for pushing pet food to move. By rotating the rotating dish, the food in the food storage bin is pushed to the edge of the food storage bin by the pushing block, and falls to the outside through the dispensing channel through the falling outlet.

### CROSS-REFERENCE TO RELATED APPLICATIONS

This is a U. S. patent application which claims the priority and benefit of Chinese Patent Application Number 202221837380.0, filed on Jul. 14, 2022, the disclosure of which is incorporated herein by reference in its entirety.

### TECHNICAL FIELD

The present application relates to the field of pet supplies, in particular to a pet toy that can automatically supply food.

### BACKGROUND

As people's living standards are getting higher and higher, there are more and more families feeding pets. In order to stimulate the brain development of pets, pet intelligence training toys have been developed in the prior art. The principle is to achieve the purpose of developing pet intelligence by obtaining food rewards when pets play with toys. In the pet toys in the prior art, when the pet uses the toy, the pet owner needs to manually add pet food, which is inconvenient to operate, and it is urgent to develop a pet toy that can automatically supply food.

### SUMMARY

The technical problem to be solved in the present application is to provide a pet toy that can automatically supply food. By rotating the rotating dish, the pet food will fall from the food storage bin of the educational toy to the outside through the dispensing channel and the falling outlet, so as to realize the automatic supply of pet food.

The technical solution provided by the present application to solve the above-mentioned technical problems is: A pet toy that can automatically supply food, comprising a base and a rotating dish, the rotating dish is provided with a food inlet, a food storage bin is arranged between the base and the rotating dish, wherein pet foods are added into the food storage bin through the food inlet, the inner edge of the food storage bin is provided with a dispensing channel, below the dispensing channel is the food falling outlet, and the lower surface of the rotating dish is provided with a pushing block for pushing pet food to move, by rotating the rotating dish, the food in the food storage bin is pushed to the edge of the food storage bin by the pushing block, and falls to the outside through the dispensing channel through the falling outlet.

The further preferred solution of the present application is: the pushing block comprises a V-shaped structure facing the periphery of the rotating dish.

The further preferred solution of the present application is: the pushing block is in a triangular shape, and two pushing sides of the pushing block form a V-shaped structure and face the periphery of the rotating dish.

The further preferred solution of the present application is: blocking ribs for preventing pet food from falling are arranged above the falling outlet, and the blocking ribs are arranged on the rotating dish and rotates synchronously, when the rotating dish is rotated, the pet food at the dispensing channel intermittently falls through the dispensing channel into the falling outlet and falls out of the toy.

The further preferred solution of the present application is: the blocking ribs are distributed around the rotating dish, and the food dispensing channel is formed between two adjacent blocking ribs.

The further preferred solution of the present application is: the pushing block is arranged at opening of the food dispensing channel.

The further preferred solution of the present application is: a plurality of said pushing blocks are provided, and the plurality of pushing blocks are distributed at different distances from the center of the rotating dish.

The further preferred solution of the present application is: the center of the rotating dish is a recessed portion formed by the food inlet being sunken inward, and an auxiliary rotating dish is arranged in the center of the recessed portion, and the auxiliary rotating dish is provided with a pushing piece, and by turning the rotating dish, the foods scattered at the food inlet will be pushed into the good storage bin through the pushing piece.

The further preferred solution of the present application is: a plurality of toggle pieces are arranged on upper surface of the rotating dish.

The further preferred solution of the present application is: the height of the upper surface of the base gradually decreases from the middle to the peripheral side.

In the present application, pet foods are loaded into the food storage bin at one time, and the lower surface of the rotating dish is provided with a pushing block and a food dispensing channel. When the pet rotates the rotating dish when playing, the rotating dish drives the pushing block and the dispensing channel to rotate. Under the action of the pushing block, the pet food enters the falling outlet through the dispensing channel, and falls out of the toy. When the pet uses the toy to play, the function of automatically supplying food to the pet is realized.

### BRIEF DESCRIPTION OF DRAWINGS

FIG. 1 is a perspective diagram of the present application;

FIG. 2 is an explosion diagram of the present application;

FIG. 3 is a cooperative schematic diagram of pushing block and blocking ribs in the present application;

FIG. 4 is a perspective diagram of the rotating dish;

FIG. 5 is a sectional diagram of the present application.

### DETAILED DESCRIPTION

The present application will be described in further detail below in conjunction with the accompanying drawings and embodiments.

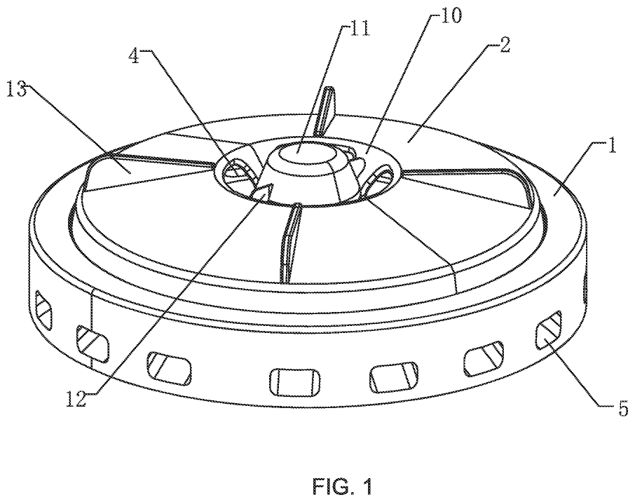

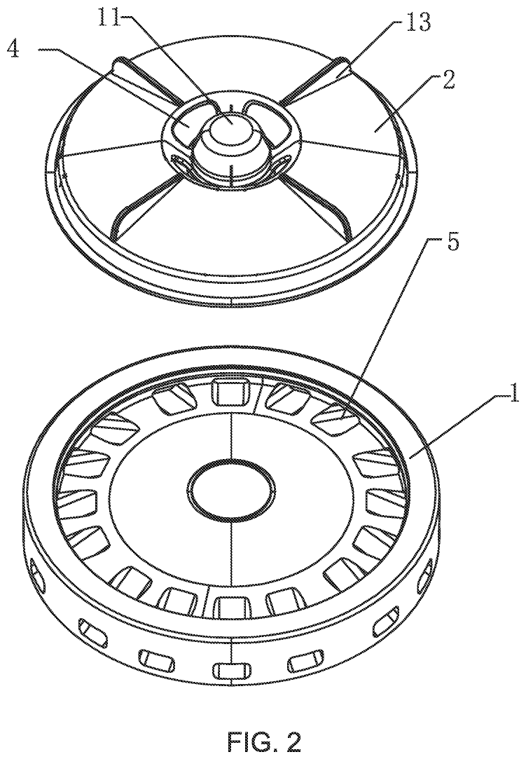

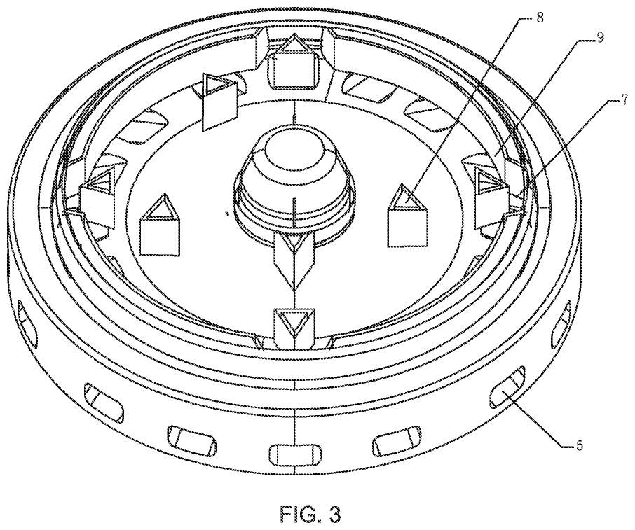

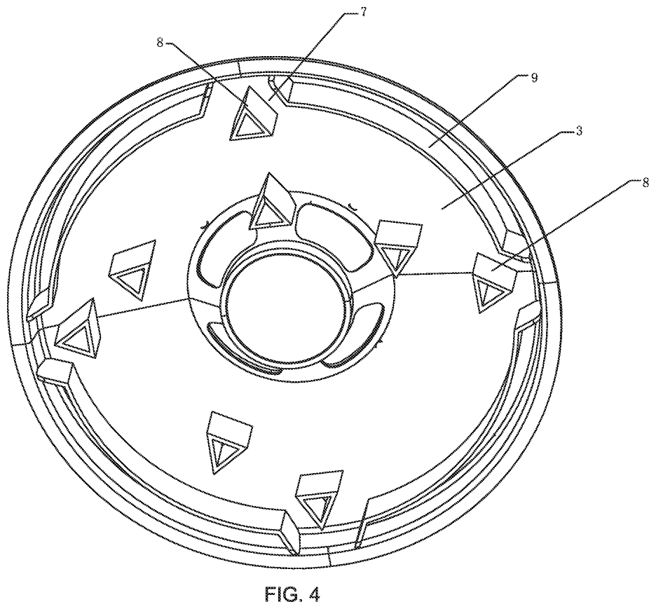

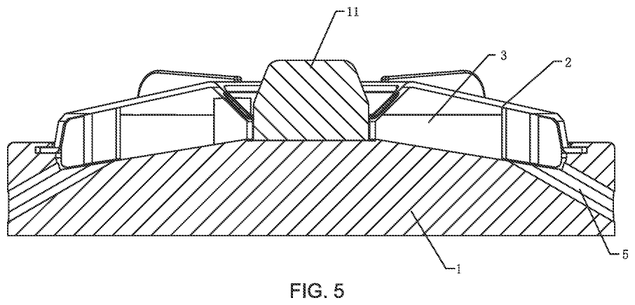

As shown in FIGS. 1-5, a pet toy that can automatically supply food comprises a base 1 and a rotating dish 2, the rotating dish 2 is arranged above the base 1, a food storage bin 3 is arranged between the base 1 and the rotating dish 2, the rotating dish 2 is provided with a food inlet 4, Wherein pet foods are added into the food storage bin 3 through the food inlet 4. A food dispensing channel 7 is arranged on the peripheral side of the rotating dish 2, and a falling outlet 5 is arranged below the food dispensing channel 7. When the food dispensing channel 7 and the falling outlet 5 are aligned, the pet food will enter the falling outlet 5 from the food dispensing channel 7. The pet can rotate the rotating 2 when playing, and the lower surface of the rotating 2 is provided with a pushing block 8 for promoting the movement of pet food, By rotating the rotating dish 2, foods in the food storage bin 3 is pushed into the dispensing channel 7 by the pushing block 8, and the pet food in the dispensing channel 7 is discharged into the outside through the falling outlet 5, the automatic supply of pet food can be realized without manual addition by the pet owner.

As shown in FIGS. 1-5, the pushing block comprises a V-shaped structure facing the periphery of the rotating dish. The V-shaped structure comprises two pushing sides. The V-shaped structure facing the periphery of the rotating dish can push the pet food to the periphery no matter whether it is rotated clockwise or counterclockwise. In a specific embodiment, the pushing block is designed as a triangle, and the two pushing sides of the pushing block form a V-shaped structure and face the peripheral side of the rotating dish. Blocking ribs 9 for preventing pet food from falling are arranged above the falling outlet 5. If the blocking rib 9 rotates to the top of the falling outlet 5, the pet food cannot fall into the falling outlet 5. The blocking ribs 9 are arranged on the rotating dish 2 and rotates synchronously. After the blocking rib 9 rotates, when the falling outlet 5 exposes enough size for the pet food to enter, the pet food will fall into the falling outlet 5. Therefore, as the rotating dish 2 rotates, the pet food located at the dispensing channel 7 intermittently falls into the falling outlet 5. The blocking ribs 9 are distributed around the rotating dish 2, and the food dispensing channel 7 is formed between two adjacent blocking ribs 9. After the rotating dish 2 rotated, the pet food was pushed to the peripheral side of the rotating dish 2 by the pushing block 8. The opening of the food leakage channel is provided with the pushing block, which is convenient for the pushing block to push the pet food into the food dispensing channel. A plurality of pushing blocks 8 are provided, and the plurality of pushing blocks 8 are distributed at different distances from the center of the rotating dish 2, and ensures that the entire rotating dish 2 is distributed with a pushing block 8 to prevent the pet food from being missed in the food storage bin 3. The center of the rotating dish 2 is inwardly recessed to form a recessed portion 10, on which the food inlet 4 is arranged, and the recessed portion 10 can help pet food enter into the food inlet 4.

As shown in FIG. 1, an auxiliary rotating dish 11 is arranged in the center of the recessed portion 10, and a pushing piece 12 is arranged on the auxiliary rotating dish 11. Rotate the auxiliary rotating dish 11, and the pushing piece 12 will push the pet food into the food inlet 4. A plurality of toggle pieces 13 are arranged on upper surface of the rotating dish 2, and the pet rotates the rotating dish 2 through the toggle piece 13. The height of the upper surface of the base 1 gradually decreases from the middle to the peripheral side. The pet food can move to the peripheral direction independently, combined with the pushing block 8, it can better move the pet food to the peripheral side.

The above is a detailed introduction of a pet toy that can automatically supply food provided by the present application. The present application uses specific examples to illustrate the principles and implementation methods of the present application, and the descriptions of the above embodiments are only used to help understand the present application and its core ideas. It should be pointed out that those skilled in the art can make some improvements and modifications to the present application without departing from the principles of the present application, and these improvements and modifications also fall within the protection scope of the claims of the present application.

1. A pet toy that can automatically supply food, comprising a base and a rotating dish, the rotating dish is provided with a food inlet, a food storage bin is arranged between the base and the rotating dish, wherein pet foods are added into the food storage bin through the food inlet, an inner edge of the food storage bin is provided with a dispensing channel, below the dispensing channel is a food falling outlet, a lower surface of the rotating dish is provided with a pushing block for pushing pet food to move, by rotating the rotating dish, the food in the food storage bin is pushed to the inner edge of the food storage bin by the pushing block, and falls to the outside through the dispensing channel through the falling outlet;
wherein the pushing block has a shape of a triangular prism, and one surface of the pushing block faces the periphery of the rotating dish.

2-3. (canceled)

4. The pet toy that can automatically supply food according to claim 1, wherein at least two blocking ribs for preventing the pet food from falling are arranged above the falling outlet, and the at least two blocking ribs are arranged on the rotating dish and rotates synchronously with a rotation of the rotating dish, when the rotating dish is rotated, the pet food at the dispensing channel intermittently falls through the dispensing channel into the falling outlet and falls out of the toy.

5. The pet toy that can automatically supply food according to claim 4, wherein the at least two blocking ribs are distributed around the rotating dish, and the food dispensing channel is formed between two adjacent blocking ribs of the at least two blocking ribs.

6. The pet toy that can automatically supply food according to claim 1, wherein the pushing block is arranged at an opening of the food dispensing channel.

7. The pet toy that can automatically supply food according to claim 1, wherein the number of the pushing blocks is at least two, and each of the at least two pushing blocks is distributed at a different distance from the center of the rotating dish, respectively.

8. The pet toy that can automatically supply food according to claim 1, wherein the center of the rotating dish is a recessed portion formed by the food inlet being sunken inward, and an auxiliary rotating dish is arranged in the center of the recessed portion, and the auxiliary rotating dish is provided with a pushing piece, and by turning the rotating dish, the foods scattered at the food inlet will be pushed into the food storage bin through the pushing piece.

9. The pet toy that can automatically supply food according to claim 1, wherein a plurality of toggle pieces are arranged on an upper surface of the rotating dish.

10. The pet toy that can automatically supply food according to claim 1, wherein the height of the upper surface of the base gradually decreases from middle to a peripheral side.
